(19) United States
(12) Patent Application Publication
(10) Pub. No.: US 2025/0377844 A1
(43) Pub. Date: Dec. 11, 2025

(54) INDUSTRIAL PRINTING SYSTEM, PRINT SERVER, AND PROCESSING MANAGEMENT METHOD FOR DISTRIBUTED PROCESSING OF LARGE NUMBER OF JOBS BY GROUPING IN PEER-TO-PEER PRODUCTION PRINTING

(71) Applicant: KYOCERA Document Solutions Inc., Osaka (JP)

(72) Inventor: Taku MATSUO, Los Angeles, CA (US)

(73) Assignee: KYOCERA Document Solutions Inc., Osaka (JP)

(21) Appl. No.: 18/736,530

(22) Filed: Jun. 7, 2024

(51) Int. Cl. G06F 3/12

(52) U.S. Cl. CPC G06F 3/1262; G06F 3/1205

(57) ABSTRACT

Provided is an industrial printing system that efficiently performs peer-to-peer production printing distributed processing through grouping. Each of the plurality of print servers includes a difference information calculating unit, a rule setting unit, a group dividing unit, and a processing management unit. The difference information calculating unit acquires a plurality of capability information indicating support capabilities, and it calculates capability difference information regarding the difference between the plurality of capability information. The rule setting unit sets a grouping rule for generating a group of the other print servers of distribution destination to request to process a job based on the capability difference information. The group dividing unit divides the plurality of jobs into groups based on the grouping rule. The processing management unit sends the jobs of the groups to the other print server specified by the grouping rule and requests processing.

### BACKGROUND

The present disclosure particularly relates to an industrial printing system, a print server, and a process management method that performs distributed processing for industrial printing (production printing).

As a typical printing system, a printing system that includes a plurality of printers capable of communicating with each other is disclosed. Each of the plurality of printers in the system includes a communication unit configured to send and receive jobs, a determination unit configured to determine whether a print setting of the job is possible to be processed by the print function of the printer, and a storage unit configured to store a job in a memory. In this system, each of the plurality of printers stores the job in the storage unit if the determination unit determines that the print settings of the received job can be processed, and it transfers the job to any one of the plurality of printers by the communication unit if the determination unit determines that the print settings of the received job cannot be processed.

Further, as another typical printing system, a system has been disclosed in which a network group consisting of a plurality of image forming apparatuses is formed into a plurality of groups in which one image forming apparatus functions as a main server. In this system, a location-free printing system is formed in which the main servers of each group share an address list of the addresses of the main servers of all groups. The job list of print jobs of the image forming apparatuses is shared by each image forming apparatus of the first group. When the user is authenticated, the image forming apparatus obtains the print job of the user registered in the first group from the job list. When acquiring a print job of a user registered in the second group, the image forming apparatus instructs the main server of the second group to acquire the print job of the user via the main server of the first group.

On the other hand, in an industrial printing called production printing, which uses commercial (industrial) printing apparatuses, components of the final product are manufactured by dividing labor into multiple processes. For example, in the case of bookbinding, the cover, main body (color), main body (black and white), promotional materials, bands, shipping envelopes, or the like, are processed as different jobs. Then, in the middle of the process, each job is combined to produce the final product, a book.

In such production printing systems, a plurality of jobs that perform the same processing are managed collectively on a management server, and a large number of print jobs are sometimes evenly divided and processed.

### SUMMARY

An industrial printing system of the present disclosure is an industrial printing system that performs production printing having a plurality of print servers for performing distributed processing of a plurality of jobs, each of the plurality of print servers includes: a difference information calculating unit that acquires a plurality of capability information indicating support capabilities from a plurality of other print servers and calculate capability difference information regarding a difference in the plurality of capability information; a rule setting unit that sets a grouping rule for generating a group of other print server of distribution destination to request to process a job based on the capability difference information calculated by the difference information calculating unit; a group dividing unit that divides the plurality of jobs into groups based on the grouping rule set by the rule setting unit; and a processing management unit that sends a job of a group divided by the group dividing unit to other print server specified by the grouping rule to request processing.

A print server of the present disclosure is a print server for performing distributed processing of a plurality of jobs in an industrial printing system that performs production printing, including: a difference information calculating unit that acquires a plurality of capability information indicating support capabilities from a plurality of other print servers and calculate capability difference information regarding a difference in the plurality of capability information; a rule setting unit that sets a grouping rule for generating a group of other print server of distribution destination to request to process a job based on the capability difference information calculated by the difference information calculating unit; a group dividing unit that divides the plurality of jobs into groups based on the grouping rule set by the rule setting unit; and a processing management unit that sends a job of a group divided by the group dividing unit to other print server specified by the grouping rule to request processing.

A processing management method of the present disclosure is a processing management method executed by an industrial printing system that performs production printing and includes a plurality of print servers for performing distributed processing of a plurality of jobs, the method including the steps of: acquiring a plurality of capability information indicating support capabilities from a plurality of other print servers; calculating capability difference information regarding a difference in the plurality of capability information; setting a grouping rule for generating a group of other print server of distribution destination to request to process a job based on the calculated capability difference information; dividing the plurality of jobs into groups based on the grouping rule; and sending a job of a divided group to other print server specified by the grouping rule to request processing.

### BRIEF DESCRIPTION OF THE DRAWINGS

FIG. 1 is an example of a system configuration diagram of an industrial printing system according to an embodiment of the present disclosure;

FIG. 2 is a block diagram showing the control configuration of the print server as shown in FIG. 1;

FIG. 3 is a block diagram showing the functional configuration of the print server as shown in FIG. 1;

FIG. 4 is a block diagram showing details of the capability and status information as shown in FIG. 3;

FIG. 5 is a block diagram showing details of the difference information as shown in FIG. 3;

FIG. 6 is a block diagram showing details of the grouping rule as shown in FIG. 3;

FIG. 7 is a block diagram showing details of the job as shown in FIG. 3;

FIG. 8 is a flowchart of a job grouping division process according to an embodiment of the present disclosure; and

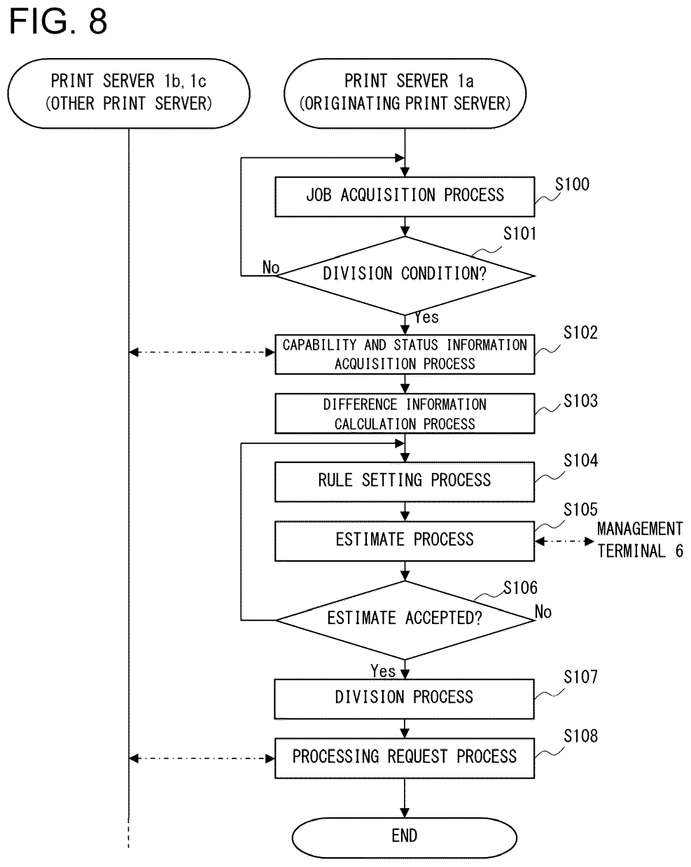

FIG. 9 shows an example of a screen for the job grouping division process as shown in FIG. 8.

### DETAILED DESCRIPTION

### <Embodiment>

### [Configuration of Industrial Printing System X]

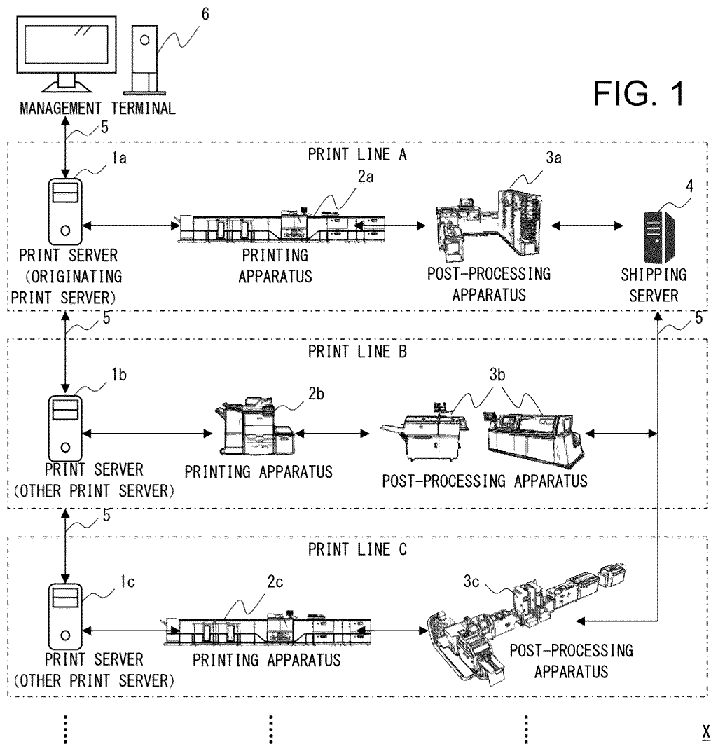

Firstly, with reference to FIG. 1, an example of the overall system configuration of an industrial printing system X according to the present embodiment is described.

The industrial printing system X according to the present embodiment is a system that executes output through a printing process and a post-processing process (hereinafter, simply referred to as “printing”) in industrial printing (production printing).

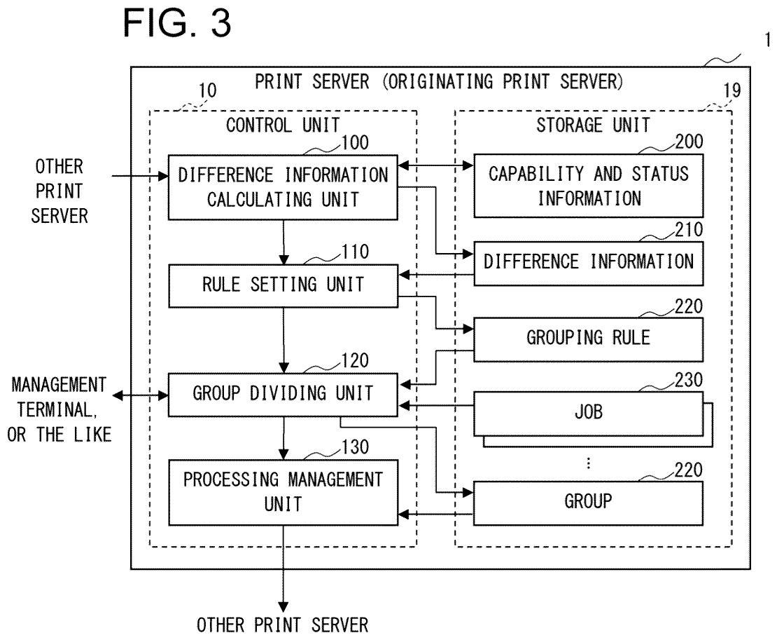

Here, in the industrial printing system X according to the present embodiment, the final product such as a book to be output is referred to as an “order,” and each component of the order is referred to as a job 230 (FIG. 3).

In the industrial printing system X, print servers 1 at sites (printing lines) such as printing companies and printing factories are connected via a network 5 and cooperated with. The print server 1 of each print line controls printing-related apparatuses (hereinafter referred to as “component apparatuses”) including a printing apparatus 2, a post-processing apparatus 3, a shipping server 4, and the like. Further, a management terminal used by a user such as an administrator of the industrial printing system X is also connected with the network 5.

In FIG. 1, as an example of cooperation between the sites, print servers 1a, 1b, 1c, . . . , of print lines A, B, C, . . . , and a shipping server 4 of print line A are connected via a network 5. Further, in this example, printing apparatuses 2a, 2b, 2c, . . . , and post-processing apparatuses 3a, 3b, 3c, . . . , are connected to the printing lines A, B, C, . . .

Hereinafter, when any one of these print servers 1a, 1b, 1c, . . . , is specified, it is simply referred to as a print server 1. Similarly, when any one of the printing apparatuses 2a, 2b, 2c, . . . , is specified, it is simply referred to as the printing apparatus 2. Similarly, when any one of the post-processing apparatuses 3a, 3b, 3c, . . . , is specified, it is simply referred to as the post-processing apparatus 3.

The print server 1 is an information processing apparatus serving as a print controller or DFE (Digital Front End), which manages and controls component apparatuses provided at each site. The print server 1 is configured as a PC (Personal Computer) server, a dedicated machine, general-purpose machine, and the like. In the present embodiment, the print server 1 assigns the processing of the job 230 to each component apparatus within the site, and it causes the processing to be executed according to a schedule.

In the present embodiment, the print server 1 sends and receives various instructions and information to and from the printing apparatus 2, the post-processing apparatus 3, the shipping server 4, or the like, in production printing. Thereby, the print server 1 manages the status of each apparatus and requests processing of the job 230.

In addition, in the present embodiment, the print server 1 executes dedicated print management (order output management) application software (hereinafter simply referred to as the “application”). This performs peer-to-peer distributed processing of the job 230 (FIG. 3) for production printing. The print management application (hereinafter referred to as a “dedicated application”) may be executed on a common platform. This common platform may perform printing design creation, user management, tenant management, security management, notification service for maintenance, prepress processing management, storage management for each document, management of the printing apparatus 2, and the like.

In the present embodiment, the print server 1 that is the requesting side of the process is hereinafter referred to as the “originating print server.” In the following example, print server 1a is the originating print server.

On the other hand, in the present embodiment, the print server that is requested to perform processing is hereinafter referred to as the “other print server.” In the following example, print servers 1b and 1c are the other print servers.

The printing apparatus 2 is an industrial printer including an image forming apparatus, an automated offset printing apparatus, and the like. The printing apparatus 2 is capable of performing print processing such as small-lot printing or large-number (multi-lot) offset printing.

The printing apparatuses 2 at each site according to the present embodiment may differ in the size of the recording paper, paper quality, color profile, printing range, or the like, used in the printing process.

The post-processing apparatus 3 is capable of performing processing after printing (post-processing) such as folding, collating, bookbinding, cutting, bookbinding, and the like, on the recording paper printed by the printing apparatus 2.

Regarding the post-processing apparatus 3 at each site according to the present embodiment, the content and range of processing that can be executed in the post-processing step may also be different.

The shipping server 4 is a server that manages shipping of orders sent from each location after printing or post-processing is completed.

In the present embodiment, an example by using the shipping server 4 provided at site A is described. However, the shipping server 4 may also be provided at other sites.

The network 5 is a LAN (Local Area Network), a wireless LAN (Wi-Fi), a WAN (Wide Area Network), a mobile phone network, an industrial network, a voice telephone network, the other dedicated line, or the like. The network 5 is capable of transmitting and receiving various commands and data to and from each apparatus. Furthermore, the print server 1 and each component apparatus may also be connected through an intra-site network such as a LAN in the network 5. In addition, the network 5 may be configured with a VPN (Virtual Private Network), or the like.

The management terminal 6 is an information processing apparatus such as a PC, a smartphone, a tablet terminal, or a PDA (Personal Data Assistant,) or the like. The management terminal 6 can be used by a user such as an administrator to control printing, or the like. In the present embodiment, the management terminal 6 sets and confirms the division processing of the job 230 by grouping and confirms the estimate of costs, and the like.

In addition, the management terminal 6 can also execute an application that controls production printing design and prepress. Further, the management terminal 6 may be connected to another manuscript submission terminal, a design proofreading terminal, or the like, for this design and prepress. In addition, the management terminal 6 may also have the functions of a management apparatus for generating jobs and managing when the print server 1 requests processing from each apparatus. Thereby, it is possible to acquire the job 230, print design, submit documents, manage prepress processing, check the progress status, request processing, and the like.

In addition, a plurality of these apparatuses may exist depending on the purpose, scale of printing, and the like. Each apparatus can be connected to the print server 1 via a network 5, LAN, or the like, by using various protocols. Alternatively, the print server 1 and each apparatus may be directly connected by wire using various interfaces.

Further, other component apparatuses managed by the print server 1 may be provided at each site. The other component apparatuses include, for example, a terminal for submitting manuscripts, a terminal for design proofreading, a prepress apparatus, and the like.

Additionally, another general terminal used by a user may be connected via the network 5 inside and outside each site. This general terminal may include a so-called console.

Thereby, each print server 1 can be accessed by a user by using a web browser, a terminal, a dedicated application, or the like, on the administrator terminal 6 or the general terminal. As a result, it is possible to acquire the jobs 230, divide them, print design, submit the job, manage prepress processing, check the progress status, request processing, and the like.

### [Control Configuration of Print Server 1]

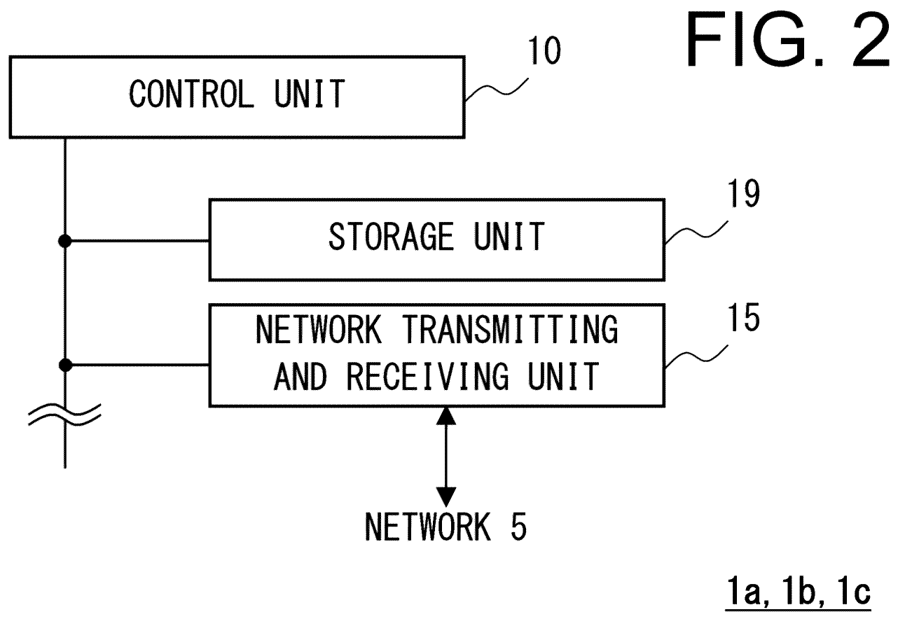

Next, with reference to FIG. 2, a control configuration of the print server 1 is described.

The print server 1 includes a control unit 10, a network transmitting and receiving unit 15, a storage unit 19, and the like. Each unit is connected to the control unit 10 and its operation is controlled by the control unit 10.

The control unit 10 is an information processing unit such as a GPP (General Purpose Processor), a CPU (Central Processing Unit), an MPU (Micro Processing Unit), a DSP (Digital Signal Processor), a GPU (Graphics Processing Unit), and an ASIC (Application Specific Integrated Circuit, a specific purpose processor), or the like.

The control unit 10 reads a control program stored in the ROM or HDD of the storage unit 19, expands this control program in the RAM, and executes it, thereby operating as each unit of the functional blocks as described later. Further, the control unit 10 controls the entire apparatus according to instruction information input from the administrator terminal 6 or the general terminal.

The network transmitting and receiving unit 15 is a network connecting unit including a LAN board, a wireless transmitting and receiving apparatus, or the like, for connecting with the network 5.

The network transmitting and receiving unit 15 transmits and receives data over a data communication line, and it transmits and receives voice signals over a voice telephone line.

The storage unit 19 is a non-transitory recording medium including semiconductor memory such as ROM (Read Only Memory) and RAM (Random Access Memory), magnetic storage such as HDD (Hard Disk Drive), and the like.

A control program for controlling the operation of the print server 1 is stored in the ROM or HDD of the storage unit 19. The control program includes an OS (Operating System), middleware on the OS, services (daemons), various applications, database data, and the like. Among these, the various applications include the above-mentioned printing process management application.

In the present embodiment, the storage unit 19 may store programs and data for processing raster in-process (hereinafter simply referred as “rasterization” or “RIP”) that converts vector (line drawing) image data into printing image data (raster data). This program and data for rasterization processing also include commercial libraries, fonts, and the like. In addition, the storage unit 19 also stores information, control programs, or the like, of component apparatuses connected to the same print line.

Furthermore, the storage unit 19 may also store account settings of the administrator (user) of the industrial printing system X, other data, and the like.

In addition, in the print server 1, the control unit 10 may be integrally formed, such as a CPU with a built-in GPU, a chip-on-module package, an SOC (System On a Chip), or the like.

Further, the control unit 10 may include a built-in RAM, ROM, flash memory, or the like.

### [Functional Configuration of Print Server 1]

Here, with reference to FIG. 3, the functional configuration of the print server 1 is described.

The control unit 10 of the print server 1 includes a difference information calculating unit 100, a rule setting unit 110, a group dividing unit 120, and a processing management unit 130.

The storage unit 19 stores capability and status information 200, difference information 210, grouping rule 220, a job 230, and a group 240.

The difference information calculating unit 100 acquires a plurality of capability information 300 from a plurality of other print servers. Based on this, the difference information calculating unit 100 calculates capability difference information 320 and stores it in the difference information 210.

The difference information calculating unit 100 also acquires a plurality of setting status information 310 from the plurality of other print servers. Based on this, the difference information calculating unit 100 also calculates status difference information 330 and stores it in the difference information 210.

The rule setting unit 110 sets the grouping rule 220 for generating the group 240 of the other print server to which the job 230 is to be distributed based on the capability difference information 320 calculated by the difference information calculating unit 100. Specifically, the rule setting unit 110 specifies any one of a print servers 1 at each site where peer-to-peer connected and capable of cooperation (hereinafter simply referred to as “a plurality of print servers 1”), a printing apparatus 2, and a post-processing apparatus 3, which can process the job 230, based on the type of the job 230 and sets them in the grouping rule 220.

At this time, the rule setting unit 110 may set the grouping rule 220 based on the capability difference information 320 regarding the color mode, post-processing, or spot color.

Furthermore, the rule setting unit 110 can set the grouping rule 220 based on the status difference information 330 as well.

At this time, the rule setting unit 110 may set the grouping rule 220 based on the status difference information 330 relating to the set paper, color profile, or throughput.

Furthermore, the rule setting unit 110 may also set a division condition 380 regarding division of the job 230 and store it in the storage unit 19.

The group dividing unit 120 divides the plurality of jobs 230 into the groups 240 based on the grouping rule 220 set by the rule setting unit 110. The group dividing unit 120 checks the capabilities required to process each job 230 (hereinafter referred to as “processing requirements”) based on the capability and status information 200. Then, the group dividing unit 120 associates the job 230 with each of the group 240 of the grouping rule 220.

At this time, the group dividing unit 120 may estimate the processing cost for the groups 240 to be divided according to each of the grouping rule 220. The group dividing unit 120 divides into optimal groups 240 based on the processing cost.

The processing management unit 130 transmits the job 230 of the group 240 divided by the group dividing unit 120 to the other print server specified by the grouping rule 220 to request processing. At this time, the processing management unit 130 causes one of the other print servers, printing apparatuses 2, and post-processing apparatuses 3 specified for each group 240 to perform the processing. More specifically, the processing management unit 130 transmits the job 230 to the other print server at the location where the specified apparatus is located.

Further, the processing management unit 130 may manage the processing of the job 230 by transmitting and receiving the job 230 itself, data processed by the job 230, and processing status notifications and completion notifications between the print servers 1.

The capability and status information 200 is information about the capabilities supported by the print server 1 and component apparatuses at each site, and the setting status of processable settings.

The details of the capability and status information 200 is described later.

The difference information 210 is information indicating the difference between the capabilities or setting states of each print server 1 calculated from the capability and status information 200.

The details of the difference information 210 is also described later.

The grouping rule 220 is setting information regarding grouping for generating a group 240 of the other print servers 1 as distribution destinations to which the job 230 is requested. Here, in the present embodiment, the wording of grouping or group division of the jobs 230 into the groups 240, division into the group 240, or the like, are simply referred to as “grouping.”

The details of the grouping rule 220 is also described later.

The job 230 is data that collects various data used during printing in production printing. The job 230 may be written in, for example, JDF (Job Description Format) and/or JMF (Job Messaging Format).

The details of the job 230 is also described later.

The group 240 is a collection of jobs 230 grouped together according to the grouping rule 220 described above. In the present embodiment, the job 230 associated with this group 240 is transmitted to another print server and requested to be processed.

### (Details of Capability and Status Information 200)

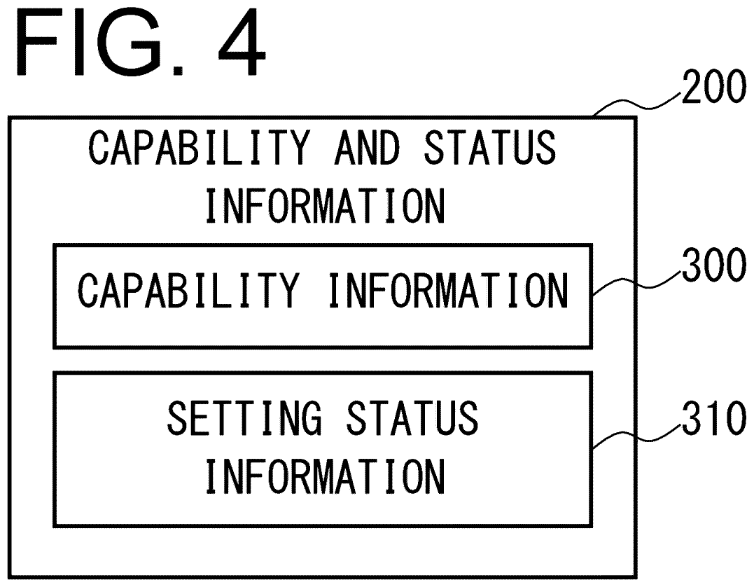

Then, with reference to FIG. 4, the details of the capability and status information 200 according to the present embodiment is explained.

In the present embodiment, the capability and status information 200 includes capability information 300 and setting status information 310.

The capability information 300 is information indicating the capabilities supported by each component apparatus connected to the print server 1 at each site.

Specifically, the capability and status information 200 includes a table indicating the rasterization processing capability of each print server 1, the print processing capability supported by printing processing by the printing apparatus 2, and the post-processing capability supported by the post-processing apparatus 3, or the like. Hereinafter, these capabilities is also simply referred to as a “processing capability.”

The rasterization processing capacity is data indicating the processing capacity when performing RIP in the print server 1. The rasterization processing capability includes, for example, color profile information, spot color information, font information, image processing information, and plug-in information.

Among these, the color profile information is information on the color gamut (color profile.) The color profile information includes data such as an ICC profile, or the like.

The spot color information is “+alpha color” information that specifies a color other than normal CMYK (Cyan, Magenta, Yellow, Key plate). Specifically, this “+alpha color” includes colors other than CMYK, such as white, transparent, gold, silver, pink, metallic, hologram printing, and the like. In addition, the spot color information includes information on commercial libraries related to color specification as so-called a “spot color.” These commercial libraries include PANTONE (registered trademark) HKS, DIC (registered trademark), TOYO (registered trademark), and the like. In the present embodiment, the color profile and spot color information settings are collectively referred to as a “color mode.”

The font information is information such as usable commercial font, and the like.

The image processing information is information indicating the image processing that can be performed and its capabilities. The image processing information includes, for example, information such as image enhancement, presence or absence of skew correction, and the like.

The plug-in information is information regarding plug-in processing. The plug-in information includes information on plug-in processing and its capabilities, such as imposition, preflight, preflight profile, and the like.

The print processing capacity is information indicating the processing capacity when the printing apparatus 2 performs print processing. The print processing capacity includes, for example, paper information, ink information, resolution information, and the like.

The paper information includes information such as paper type, tray information, size, and orientation.

The ink information is information such as color, monochrome, other supported colors, spot colors, and other special colors. The other special colors include, for example, special designations such as a metallic color, conductive ink, UV curable ink, or the like.

The resolution information is information indicating the resolution at the time of printing. For example, values such as 600 dpi (dots per inch), 1200 dpi, or the like, is set as the resolution information.

In addition, the print processing capacity may include information such as halftone, trapping, scaling, presence or absence of borderless printing, inventory status of other resources necessary for printing, or the like.

The post-processing capacity is data indicating the processing capacity when performing processing process after printing (post-processing) in the post-processing apparatus 3.

The cutting information includes whether or not cutting is possible, the maximum thickness, and other information necessary for cutting.

The folding information includes information such as whether folding is possible or not.

The bookbinding information includes information such as whether bookbinding is possible or not, the types of possible bookbinding, or the like.

The post-processing capacity may also include information about the processing capacity of post-processing apparatuses other than these. For example, the post-processing capability may include information such as whether or not it is possible or not to perform streaking, perforation, binding, eyelet punching, or the like.

The setting status information 310 is information indicating the setting status of settings that can be processed. Specifically, the setting status information 310 includes information on the setting state of the “Ready” state in which processing is actually possible among the rasterization processing capability, printing processing capability, and post-processing capability of the capability information 300.

Here, for example, if a spot color or a font cannot be used because the print server 1 is processing the other printed matter, or the like, the setting status information 310 includes, information on the processing capacity of the rasterization processing settings that can actually be used or processed other than these.

Further, as the setting status of the print process, the setting status information 310 also includes information such as the status of the ink that is installed and has a sufficient amount remaining, the paper that is currently set in the paper tray and ready for printing, and the like. In addition, the setting status information 310 may include information such as the inventory status of available paper, or the like. Further more, the setting status information 310 may include information on the remaining amount of ink and spare ink.

Further, as the setting status of post-processing, the setting status information 310 may include information such as the inventory status of post-processing resources, the inventory status of consumables, and the like. Specifically, the setting status information 310 is also includes information on the state of staples and glue that can be used in bookbinding.

The setting status information 310 also includes information on output speeds (hereinafter referred to as “throughput”) regarding printing and post-processing for a paper. This output speed may be set, for example, as a value such as the number of pages processed per minute (PPM).

In addition to this, the capability and status information 200 may also include alternative settings regarding replaceable capabilities and setting states. The alternative setting may include, for example, whether the color mode, font, or the like, can be replaced or not. Further, the alternative settings may include settings such as to what extent the replacement is allowed if the replacement is possible.

Furthermore, the capability information 300 may also include throughput information.

### (Details of Difference Information 210)

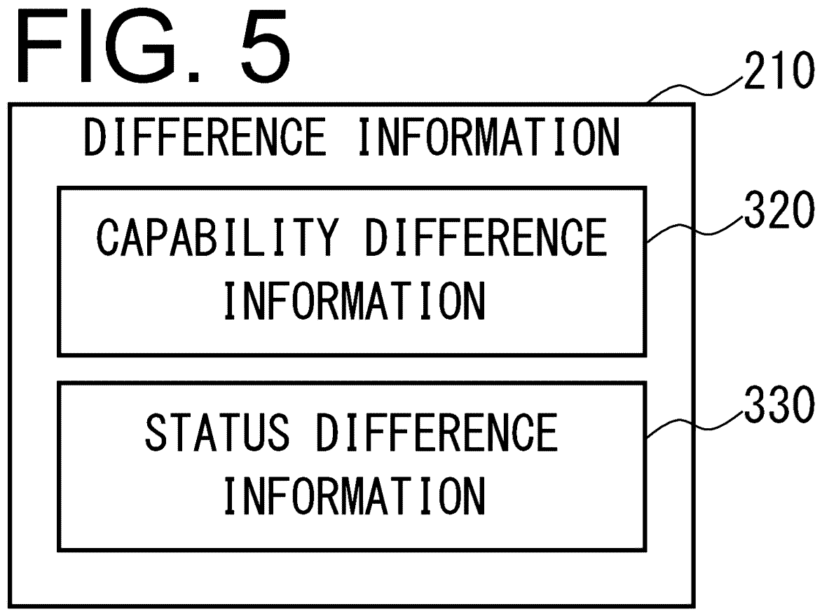

Then, with reference to FIG. 5, the details of the difference information 210 according to the present embodiment is explained.

In the present embodiment, the difference information 210 includes capability difference information 320 and status difference information 330.

The capability difference information 320 is

information about the difference between the plurality of capability information 300. Specifically, the capability difference information 320 may include information on differences in rasterization processing capability, print processing capability, and post-processing capability of component apparatuses between the print servers 1.

The status difference information 330 is information about the difference between the plurality of setting status information 310. Specifically, the status difference information 330 may indicate information on the difference in the setting status of the “Ready” status between the print servers 1.

### (Details of Grouping Rule 220)

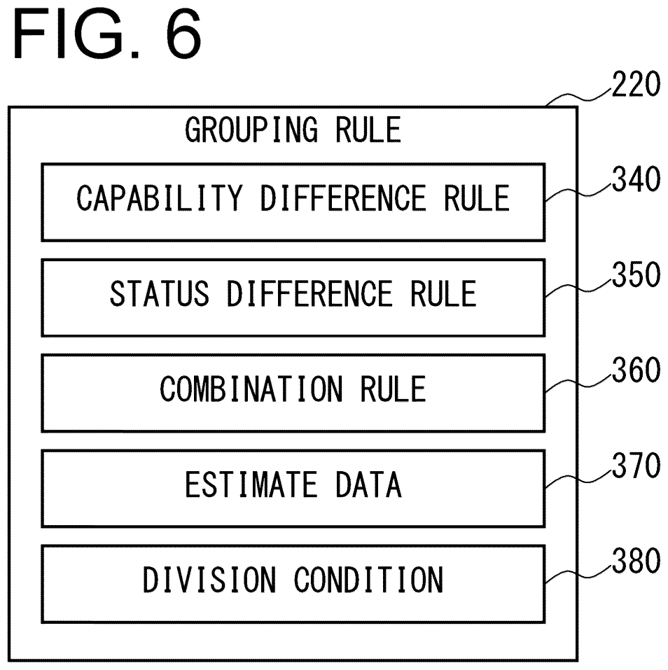

Next, with reference to FIG. 6, the details of the grouping rule 220 according to the present embodiment is explained.

In the present embodiment, the grouping rule 220 includes a capability difference rule 340, a status difference rule 350, a combination rule 360, estimate data 370, and a division condition 380.

The capability difference rule 340 is a rule setting for grouping based on the capability difference information 320. For example, the capability difference rule 340 may be a division pattern rule set by comparing the information of the job 230 with differences in rasterization processing capability, print processing capability, and post-processing capability. Specifically, for example, the capability difference rule 340 may be a rule set based on the capability difference information 320 regarding color mode, post-processing, or spot color. Among these, for example, the color mode rule is a rule for grouping based on the difference in color mode specified in the job 230. The post-processing rule is, for example, a rule for grouping based on the type of post-processing specified in the job 230.

The status difference rule 350 is a rule setting for grouping based also on the status difference information 330. The status difference rule 350 may be, for example, a division pattern rule set by comparing the information of the job 230 and the difference between the setting status information 310. Specifically, the status difference rule 350 may be a rule set based on the status difference information 330 regarding paper, color mode, or throughput. Among these, the paper rule is a rule for grouping based on the paper type specified in the job 230, for example. The color mode rule is, for example, a rule for grouping based on the difference when the color profile of the color mode is different. The throughput rule is, for example, a rule for grouping by the throughput threshold when the throughput is different.

The combination rule 360 is a rule that is a combination of set rules. Specifically, the combination rule 360 may be a rule setting that combines the capability difference rule 340 and the status difference rule 350. For example, the combination rule 360 can be set a rule to apply a specific rule of the status difference rule 350 after applying a specific rule of the capability difference rule 340. Alternatively, the combination rule 360 can be set a rule to apply a specific rule of the capability difference rule 340 after applying a specific rule of the status difference rule 350.

The estimate data 370 is estimate data when the group 240 is generated by grouping. For example, the estimate data 370 may include a cost estimate, a time estimate for printing and post-processing, an estimate for the amount of consumables such as ink, paper, and the like, or the other cost estimates. Furthermore, in the present embodiment, the estimate data 370 may include a list of the estimates for these rules set in the grouping rule 220, or the like.

The division condition 380 is a setting of a specific condition for dividing the job 230 into the groups 240. The division conditions 380 may be set, for example, a condition such as the number of jobs 230 stored in the storage unit 19, the number of output sheets, time (period), and the like. The condition may be set to a value suitable for dividing the job 230 into the groups 240 for execution. For example, the condition may be related to the timing at which a large number of jobs 230 are accumulated. Further, the division condition 380 may be set by the rule setting unit 110 by using a GUI (Graphical User Interface) of a web browser or the dedicated application on the management terminal 6.

### (Details of Job 230)

Then, with reference to FIG. 6, the details of the job 230 is explained.

In the present embodiment, data used for rasterization, printing, and post-processing in the job 230 is mainly described.

The job 230 includes job information 400, job ticket 410, print data 420, print resources 430, and the like. Further, the job 230 may include RIP data 440 depending on the type of job 230.

The job information 400 is data that includes attributes specified in print processing (hereinafter referred to as “specified attributes”). In the job information 400, as specified attributes, the type of job 230, the name of the job 230, the name of the project (order), the designation of the printing apparatus 2 or the post-processing apparatus 3, the number of copies and whether or not to collate, whether or not to record, and the trimming mm value, printing direction, printing status, priority, or the like, are set. Among these, the types of jobs 230 include jobs that perform rasterization processing (rasterization jobs), jobs that perform print processing (print jobs), and jobs that perform post-processing (post-processing jobs).

The job ticket 410 is setting data that includes print instruction attributes for requesting the job 230. The job ticket 410 includes, as print instruction attributes, lower-level settings in the workflow, which is an order setting. The lower-level settings may include settings necessary for the printing process and post-processing process, such as color mode specification, imposition specification, paper specification, bookbinding specification, or the like. In the present embodiment, the job ticket 410 may include reservation information for specifying the printing apparatus 2 or the post-processing apparatus 3. The reservation information may correspond to the group 240 described above.

Further, the job ticket 410 may also be written in JDF and/or JMF.

The print data 420 is data of a print document where the design is set according to the order. The print data 420 may be, for example, electronic document data such as PDF (Portable Document Format), PS (Post Script) data, other vector data, data in a submission format, other raster image data, or the like.

The print resources 430 is information on various resources necessary for printing instructions such as color mode, font, or the like. These various resources correspond to the capability and status information 200.

The other resource data necessary for printing may also be included in the print resources 430.

The RIP data 440 is data such as a PDF, or the like, which includes image data that has been rasterized based on the job ticket 410. This image data may be, for example, TIFF or other bitmap data. In addition, the image data may be reversibly compressed or irreversibly compressed.

In addition, the job 230 may include processing change record information for changes during processing.

Further, the storage unit 19 may also store schedule information indicating the schedule status regarding the execution of each job 230. This schedule information may include the status of the job 230, shipping record, operating status of each component apparatus, and the like. Among these, the shipping record is information regarding the physical shipping of printed matter after printing, and, for example, it may include information such as printing completion time, shipping time, receiving time, and the like.

Here, the control unit 10 of the print server 1 can be functioned as a difference information calculating unit 100, a rule setting unit 110, a group dividing unit 120, and a process management unit 130 by executing a control program stored in the storage unit 19.

Further, each part of the print server 1 as described above becomes a hardware resource that executes the process management method according to the present disclosure.

In addition, a part or any combination of the above functional configurations may be configured in terms of hardware or circuitry by using an IC, programmable logic, FPGA (Field-Programmable Gate Array), or the like.

### [Job Grouping Division Process by Print Server 1]

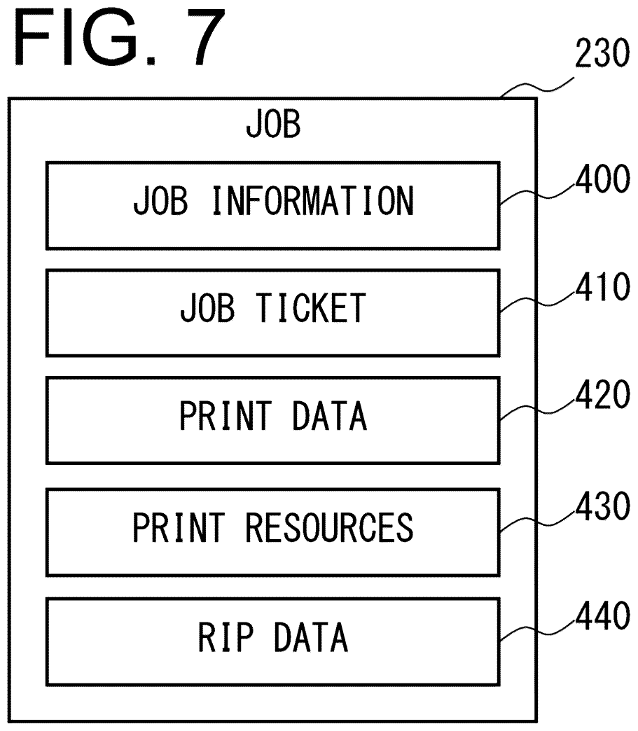

Next, with reference to FIGS. 6 and 7, a job grouping division process by using the print server 1 according to the embodiment of the present disclosure is explained.

In the job grouping division process according to the present embodiment, the capability information 300 is acquired from a plurality of print servers 1, and capability difference information 320 is calculated. Then, the grouping rule 220 is set based on the calculated capability difference information 320. Then, the plurality of jobs 230 are divided into the groups 240 based on the set grouping rule 220. Then, the job 230 of the divided group 240 is sent to the other print server specified by the grouping rule 220 and is requested to be processed.

In the job grouping division process according to the present embodiment, an example is described: the print server la of print line A (site) is used as the originating print server (processing request side), and the control unit 10 of this print server la mainly executes a program stored in the storage unit 19 cooperating with each part and by using hardware resources.

As described below, with reference to the flowchart of FIG. 6, the details of the job grouping division process is explained step by step.

### (Step S100)

Firstly, the processing management unit 130 performs a job acquisition process.

The processing management unit 130 acquires the job 230, for example, via the administrator terminal 6 and stores in the storage unit 19 one after another. The job 230 may be created by the administrator terminal 6 for a manuscript submitted by a manuscript submission terminal. Further, the job 230 may be acquired from a plurality of print servers 1, an inter-site management system upstream of the industrial printing system X, the administrator terminal 6 itself, a prepress apparatus, or the like.

### (Step S101)

Then, the processing management unit 130 determines whether the division condition is satisfied or not. The processing management unit 130 determines the number of jobs 230 stored in the storage unit 19, the number of output sheets, the output time, or the like. If these satisfy the division condition 380, the processing management unit 130 determines Yes. If the division condition 380 is not yet satisfied, the processing management unit 130 determines No.

In the case of Yes, the rule setting unit 110 advances the process to step S102.

In the case of No, the rule setting unit 110 returns the process to step S101 and continues acquiring the job 230.

### (Step S102)

If the division condition is satisfied, the difference information calculating unit 100 performs capability and status information acquisition process.

The difference information calculating unit 100 acquires capability information 300 and setting status information 310 from, for example, the plurality of print servers 1, and stores them in the storage unit 19 as the capability and status information 200.

### (Step S103)

Then, the difference information calculating unit 100 performs difference information calculation process.

The difference information calculating unit 100 calculates capability difference information 320 from the difference between the plurality of capability information 300. Specifically, the difference information calculating unit 100 calculates the difference in processing capacity between each component apparatus of the print server 1 serving as a distribution destination. For example, the difference information calculating unit 100 calculates the difference between rasterization processing capacity, print processing capacity, and post-processing capacity, and stores it in the difference information 210.

Further, the difference information calculating unit 100 also calculates status difference information 330 from the difference between the plurality of setting status information 310. The difference information calculating unit 100 310. calculates the difference between each component apparatus of the print server 1 serving as a distribution destination for the “Ready” state setting state and stores it in the difference information 210.

### (Step S104)

Here, the rule setting unit 110 performs rule setting process.

The rule setting unit 110 generates the grouping rule 220 from the calculated difference information 210 based on differences in processing capabilities and setting states among the component apparatuses of the plurality of print servers 1 serving as distribution destinations.

In this process, at first, the rule setting unit 110 sets

the capability difference rule 340 based on the capability difference information 320 regarding color mode, post-processing, or spot color.

Specifically, the rule setting unit 110 generates a grouping rule 220 based on the calculated processing capacity difference.

For example, if the printing apparatus 2 of the print server 1 that is the distribution destination has different print processing capabilities in color mode, such as black and white, CMYK color, CMYK+alpha color, or the like, the rule setting unit 110 can set the grouping rule 220 that performs grouping according to the color mode specified in the job 230.

Alternatively, for example, as a more detailed rule, if the spot colors that can be processed by the printing apparatus 2 at the distribution destination are different, the rule setting unit 110 can also set the grouping rule 220 for grouping by the spot color specified in the job 230.

On the other hand, for example, if the post-processing that can be performed by the printing apparatus 2 at the distribution destination is different, the rule setting unit 110 can also set a grouping rule 220 that performs grouping according to the post-processing specified in the job 230.

In addition, the rule setting unit 110 sets the status difference rule 350 based on status difference information 330 regarding the paper set in the printing apparatus 2, the color mode, or the throughput of the print server 1 as the distribution destination.

For example, if different paper is set in the paper feed tray of the printing apparatus 2 of the print server 1 as is the distribution destination, the rule setting unit 110 can set the grouping rule 220 that groups the paper types specified in the job 230.

On the other hand, for example, if the status of color profiles such as ICC profiles available on the print server 1 as the distribution destination is different, the rule setting unit 110 can set the grouping rule 220 such that the grouping is performed by the color profile specified in the job 230.

Furthermore, the rule setting unit 110 can also generate a combination rule 360 that is a combination of rules set in the grouping rule 220.

Specifically, the rule setting unit 110 may generate a rule that is a combination of the rule set in the capability difference rule 340 and the rule set in the status difference rule 350.

For example, the rule setting unit 110 can set the grouping rule 220 such as grouping by color mode and further grouping by paper type.

### (Step S105)

Then, the group dividing unit 120 performs estimate process.

The group dividing unit 120 estimates the processing cost of the group 240 into which the job 230 is divided according to the rules set in the grouping rule 220.

Firstly, the group dividing unit 120 divides the job 230 for each generated rule, and it calculates the processing cost of each group 240. This processing cost may be calculated from the number of printed pages of the job 230, the throughput of the printing apparatus 2, and the like.

Alternatively, if the print server 1 at the distribution destination can estimate the processing time of the job 230, send information about each job 230 of the group 240 to the print server 1 at the distribution destination to request calculation of the processing cost.

In such cases, the group dividing unit 120 may send a list of processing costs when dividing according to each rule to the dedicated application or the web browser of the management terminal 6.

The group dividing unit 120 may sort this list based on a specific processing cost criterion so that the optimal group 240 is placed at the top. The criteria for this specific processing cost criterion may be set such as emphasizing cost, emphasizing processing time, emphasizing small use of consumables, or the like. Alternatively, when sorting, the group dividing unit 120 may select the optimal one by using processing of statistics such as genetic algorithm or AI (Artificial Intelligence).

The GUI of the dedicated application of the management terminal 6 can display these as a list including the processing cost, processing time, amount of consumables, other costs, or the like, for each group 240.

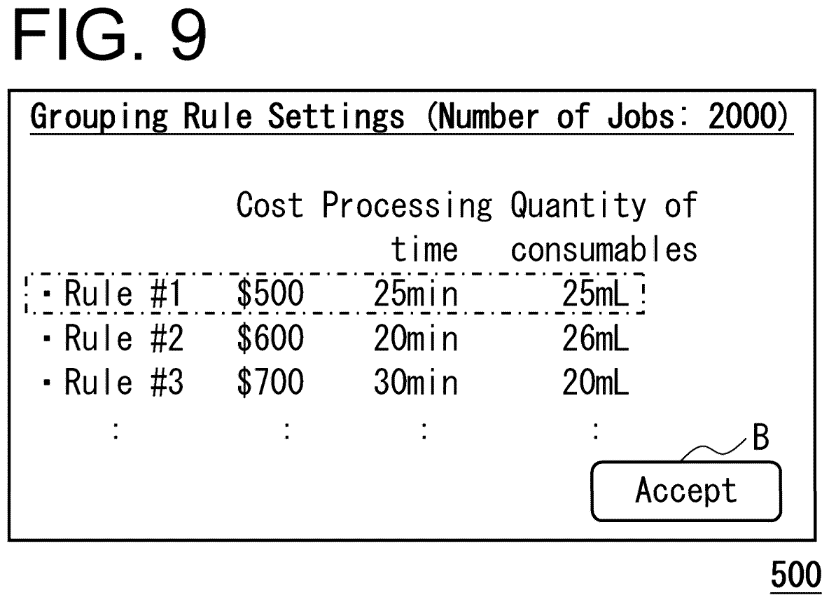

FIG. 9 shows a screen example 500 for a list display. In this screen example, on the GUI, the user can check the optimal rule for dividing by each rule and press to instruct selection.

Alternatively, the user can also instruct the above-mentioned specific processing cost standard, rule settings for the grouping rule 220, or the like, by using the GUI. At this time, the user may be allowed to make settings by using a template, or the like, by using the dedicated application or the web browser.

The group unit 120 can obtain these user instructions and the estimate approval instruction, which is described below, from the management terminal 6.

### (Step S106)

Then, the group dividing unit 120 determines whether the estimate has been approved or not. The group dividing unit 120 determines Yes if the user instructs to approve the estimate by using the GUI of the dedicated application, the web browser, or the like. In the example of FIG. 9, the user can input approval of the estimate by pressing the “Accept” button B. In other cases, the processing management unit 130 determines No.

In the case of Yes, the rule setting unit 110 advances the process to step S107.

In the case of No, the rule setting unit 110 returns the process to step S104 and continues setting the grouping rule 220.

### (Step S107)

If the estimate is approved, the group dividing unit 120 performs division process.

The group dividing unit 120 divides the plurality of jobs 230 into groups 240 based on the rules set in the grouping rule 220 and instructed by the user.

Specifically, the group dividing unit 120 analyzes the job 230 based on the grouping rule 220 and determines processing requirements. At this time, the group dividing unit 120 determines the processing requirements for printing and post-processing from the job information 400, job ticket 410, print data 420, and print resources 430 included in the job 230, and sets the distribution to each group 240. Then, the group dividing unit 120 stores the group 240 including the set jobs 230 in the storage unit 19.

For example, the group dividing unit 120 determines processing requirements based on the job information 400, the type of job 230, and other information.

Alternatively, the group dividing unit 120 analyzes the job ticket 410 such as JDF and/or JMF, and it determines the designated print instruction attributes such as color mode designation, imposition designation, paper designation, bookbinding designation, or the like.

Further, if the print data 420 is a PDF, or the like, the group dividing unit 120 determines the attributes specified in the print data 420 by performing a preflight check. This designated attribute may be spot color designation, font designation, or the like.

In addition, the group dividing unit 120 can also determine necessary processing requirements from the print resources 430.

When checking these processing requirements, the group dividing unit 120 also determines whether commercial library and plug-in processing are designated or not.

Then, the group dividing unit 120 associates the job 230 that matches the rule of each group 240 of the grouping rule 220 with the group 240.

### (Step S108)

Then, the processing management unit 130 performs processing request process.

The processing management unit 130 transmits the job 230 to the other print server at the distribution destination in units of groups 240 and requests processing.

Specifically, the processing management unit 130 sequentially transmits the job 230 of the group 240 to the other print servers specified by the grouping rule 220. As a result, the job 230 is executed at each site for rasterization processing, printing processing, and post-processing. The processing management unit 130 may request processing to encrypt the job 230 and send it to the other print server when transferring.

Further, before and after this processing request and processing completion, the processing management unit 130 may transmit and receive processing status notifications and completion notifications of the job 230 between the print servers 1. That is, the processing management unit 130 can manage processing status and processing completion between the originating print server and the other print servers.

With the above, the job grouping division process according to the embodiment of the present disclosure is completed.

** As configured in this way, the following effects can be obtained.

In a typical production printing system, print processing is distributed among a plurality of printers in order to efficiently process a large number of print jobs. At this time, a plurality of jobs that perform the same processing may be evenly divided and distributed processing may be performed.

However, for example, when simply dividing the plurality of jobs evenly and performing distributed processing, there are the situations that the job may have settings that prevent it from being printed on the destination printing apparatus, or the paper in the paper feed tray may need to be changed, or the like. Thus, sometimes it has been more time consuming and resulted in inefficiency.

On the other hand, the industrial printing system X according to the present embodiment is an industrial printing system that performs production printing, and includes a plurality of print servers 1 that perform distributed processing of a plurality of jobs 230, and each of the plurality of print servers 1 includes a difference information calculating unit 100 that acquires a plurality of capability information 300 indicating support capabilities from a plurality of the other print servers 1, and calculates capability difference information 320 regarding a difference between the plurality of capability information 300; a rule setting unit 110 that sets a grouping rule 220 for generating a group 240 of the other print server 1 to request the job 230 based on the capability difference information 320 calculated by the difference information calculating unit 100; a group dividing unit 120 that divides the plurality of jobs 230 into groups 240 based on the grouping rule 220 set by the rule setting unit 110; and a processing management unit 130 that sends the job 230 of the group 240 divided by the group dividing unit 120 to the other print server specified by the grouping rule 220 to requests processing.

With this configuration, when dividing the large number of the jobs 230, the jobs 230 can be divided into groups 240 in consideration of the processing capabilities and settings of the print server 1 and its component apparatuses at the distribution destination. Therefore, a large number of jobs 230 can be efficiently distributed and processed. As a result, when the large number of the job 230 is printed at the plurality of sites, efficient distributed processing can be performed.

Furthermore, in the industrial printing system X, the difference information calculating unit 100 further acquires a plurality of setting status information 310 indicating setting states of processable settings from the plurality of other print s and calculates status difference information 330 regarding a difference in the plurality of setting status information 310, the rule setting unit 110 sets the grouping rule 220 based on the status difference information 330, the group dividing unit 120 further divides the groups 240 divided based on the capability difference information 320 by using the grouping rule 220 based on the status difference information 330 or further divides the groups 240 divided based on the status difference information 330 by using the grouping rule 220 based on capability difference information 320.

With this configuration, when dividing a large number of jobs 230, it is possible to perform grouping that takes into consideration the setting status of the print server 1 and its component apparatuses to which the job 320 is distributed. Therefore, set changes such as paper set changes during printing can be minimized. As a result, printing operations can be made more efficient.

On the other hand, distributed processing in which print processing is performed in a distributed manner among a plurality of printing apparatuses requires a management server that transmits and manages print data to the plurality of printing apparatuses.

Therefore, in production printing, there has been a need for an industrial printing system that can realize grouping through flexible and efficient distributed processing on a peer-to-peer basis without using the management server.

On the other hand, the industrial printing system X according to the present embodiment can achieve grouping through flexible and efficient distributed processing on a peer-to-peer basis without using the management server. That is, by grouping, the plurality of print lines can cooperate and the overall printing process can be made more efficient. Specifically, grouping can be performed flexibly without being limited to one printing line.

*Further, in the industrial printing system X according to the present embodiment, the rule setting unit 110 sets the grouping rule 220 based on the capability difference information 320 regarding color mode, post-processing, or spot color.

with this configuration, it is possible to change the grouping if there is a difference in capability with respect to color mode, post-processing, or spot color. This eliminates the time and effort to manually adjust the print server 1, printing apparatus 2, and post-processing apparatus 3 at the time of printing for each job 230 due to different capabilities regarding color mode, post-processing, or spot color.

In the industrial printing system X according to the present embodiment, the rule setting unit 110 sets the grouping rule 220 based on the status difference information 330 regarding set paper, color mode, or throughput.

With this configuration, it is possible to change the grouping even if the set paper, color mode, or throughput capacity is the same but the setting state is different. This saves the effort of manually adjusting the printing apparatus 2 and post-processing apparatus 3 at the time of printing for each job 230 due to different settings regarding paper, color mode, or throughput.

Furthermore, in the industrial printing system X according to the present embodiment, the group dividing unit 120 estimates processing cost for the groups 240 to be divided according to each of the grouping rule 220 and divides into optimal groups 240 based on the processing cost.

With this configuration, the large number of jobs 230 can be divided into the groups 240 according to the characteristics of the jobs 230 by using an optimal grouping rule 220, and distributed processing can be performed. Therefore, the job 230 can be processed by grouping more efficiently at lower cost.

Further, in the industrial printing system X according to the present embodiment, the rule setting unit 110 sets a division condition 380 and performs grouping when the division condition 380 is satisfied.

With this configuration, processing requests can be made efficiently by grouping, and the overall processing of the large number of jobs 230 can be made more efficient.

Furthermore, the industrial printing system X according to the present embodiment can be configured as the originating print server and the other print servers simply by storing the capability and status information 200 in the existing print server 1 and installing a dedicated application, or the like, in it.

With this configuration, the print servers 1 can cooperate with each other on a peer-to-peer basis. Therefore, it becomes possible to easily link between the sites of existing companies, or the like, and improve efficiency by grouping.

### [Other Embodiments]

In addition, in the above-described embodiment, the capability information 300 is acquired when the division condition 380 is satisfied by acquiring the jobs 230.

However, the difference information calculating unit 100 may acquire the capability information 300 from the plurality of print servers 1 independently of collecting the jobs 230 and share it with the other print servers 1.

Furthermore, in the embodiment described above, an example has been described in which the grouping rule 220 is set when a large number of jobs 230 are stored.

However, apart from acquiring the job 230, it is also possible to set the grouping rule 220 according to the division condition 380 or even if the division condition 380 is not satisfied.

By configuring in this way, it becomes possible to respond to a flexible configuration. Therefore, for example, it is possible to flexibly set the grouping rule 220 at any necessary time.

Further, in the above-described embodiment, an example in which a plurality of jobs 230 are divided is described, but it is also possible to divide the job 230 itself and group the divided jobs 230 according to the grouping rule 220.

With this configuration, even if there are parts of the job 230 where the groups 240 to be grouped are different, efficient distributed processing can be performed. Further, even if a trouble occurs, the job 230 can be executed by distributed processing.

Further, in the above embodiment, an example has been described in which the job 230 is divided without distinguishing between rasterization processing, print processing, and post-processing of the job 230.

However, the job 230 may be divided into separate groups 240 in the rasterization process, printing process, and post-processing process. In addition, priorities may be given as to which apparatus should perform rasterization processing, printing processing, and post-processing. In addition to the setting status information 310, the priority order may be set based on the amount of availability according to schedule information, the number and performance of component apparatuses, cost, and other information.

With this configuration, grouping can be performed flexibly according to the type and number of printing apparatuses 2 and post-processing apparatuses 3 at the site. Further, it becomes possible to distribute and process the job 230 to each site more efficiently.

Furthermore, in the above-described embodiment, an example has been described in which the capability and status information 200 of a plurality of print servers 1 is stored in the originating print server or acquired from the other print server.

However, a configuration is also possible in which only the processing requirements of the job 230 are determined at the originating print server, and the processing requirements are transmitted to the plurality of print servers 1 to determine whether they can be processed. In this case, each print server 1 may determine whether processing is possible based on the processing requirements of the job 230 and the capability and status information 200 stored in its own storage unit 19. In such case, the group dividing unit 120 of each print server 1 other than the originating print server may directly group the jobs 230 according to the grouping rule 220 and request processing to the other print server.

With this configuration, it is possible to determine whether the job 230 can be processed without acquiring the capability and status information 200 of the other print servers.

Furthermore, in the embodiment described above, an example has been described in which the job 230 is directly requested to be processed by the other print server as it is.

However, it is also possible to change the job 230 itself in response to a status notification, completion notification, error notification, or the like, for the job 230.

At this time, it is also possible to change the job 230 according to process change information and alternative settings. That is, for example, when adjusting a processing request due to a delay, it is possible to change the number of pages, the color profile to be used, or the like, as the processable job 230 according to the alternative setting.

Furthermore, in the embodiments described above, an example of distributed peer-to-peer processing has been described.

However, each process of the present embodiment can also be applied to a configuration using a management server.

Also, as the terminology is used herein, the singular forms “a,” “an,” and “the” include plural forms unless the context clearly dictates otherwise.

Further, the configuration and operation of the embodiment described above are merely examples, and it goes without saying that the configuration and operation of the embodiment can be modified and executed as appropriate without departing from the aim of the present disclosure.

What is claimed is:

1. An industrial printing system that performs production printing having a plurality of print servers for performing distributed processing of a plurality of jobs, each of the plurality of print servers comprises:
a difference information calculating unit configured to acquire a plurality of capability information indicating support capabilities from a plurality of other print servers and calculate capability difference information regarding a difference in the plurality of capability information;
a rule setting unit configured to set a grouping rule for generating a group of other print server of distribution destination to request to process a job based on the capability difference information calculated by the difference information calculating unit;
a group dividing unit configured to divide the plurality of jobs into groups based on the grouping rule set by the rule setting unit; and
a processing management unit configured to send a job of a group divided by the group dividing unit to other print server specified by the grouping rule to request processing.

2. The industrial printing system according to claim 1, wherein:
the difference information calculating unit further acquires a plurality of setting status information indicating setting states of processable settings from the plurality of other print servers and calculates status difference information regarding a difference in the plurality of setting status information,
the rule setting unit sets the grouping rule based on the status difference information,
the group dividing unit further divides the groups divided based on the capability difference information by using the grouping rule based on the status difference information or further divides the groups divided based on the status difference information by using the grouping rule based on capability difference information.

3. The industrial printing system according to claim 1, wherein:
the rule setting unit sets the grouping rule based on the capability difference information regarding color mode, post-processing, or spot color.

4. The industrial printing system according to claim 2, wherein:
the rule setting unit sets the grouping rule based on the status difference information regarding paper, color mode, or throughput.

5. The industrial printing system according to claim 1, wherein:
the group dividing unit estimates processing cost for the groups to be divided according to each of the grouping rule and divides into optimal groups based on the processing cost.

6. A print server for performing distributed processing of a plurality of jobs in an industrial printing system that performs production printing, comprising:
a difference information calculating unit configured to acquire a plurality of capability information indicating support capabilities from a plurality of other print servers and calculate capability difference information regarding a difference in the plurality of capability information;
a rule setting unit configured to set a grouping rule for generating a group of other print server of distribution destination to request to process a job based on the capability difference information calculated by the difference information calculating unit;
a group dividing unit configured to divide the plurality of jobs into groups based on the grouping rule set by the rule setting unit; and
a processing management unit configured to send a job of a group divided by the group dividing unit to other print server specified by the grouping rule to request processing.

7. The print server according to claim 6, wherein:
the difference information calculating unit further acquires a plurality of setting status information indicating setting states of processable settings from the plurality of other print servers and calculates status difference information regarding a difference in the plurality of setting status information,
the rule setting unit sets the grouping rule based on the status difference information,
the group dividing unit further divides the groups divided based on the capability difference information by using the grouping rule based on the status difference information or further divides the groups divided based on the status difference information by using the grouping rule based on capability difference information.

8. The print server according to claim 6, wherein:
the rule setting unit sets the grouping rule based on the capability difference information regarding color mode, post-processing, or spot color.

9. The print server according to claim 7, wherein:
the rule setting unit sets the grouping rule based on the status difference information regarding paper, color mode, or throughput.

10. The print server according to claim 6, wherein:
the group dividing unit estimates processing cost for the groups to be divided according to each of the grouping rule and divides into optimal groups based on the processing cost.

11. A processing management method executed by an industrial printing system that performs production printing and includes a plurality of print servers for performing distributed processing of a plurality of jobs, the method comprising the steps of:
acquiring a plurality of capability information indicating support capabilities from a plurality of other print servers;
calculating capability difference information regarding a difference in the plurality of capability information;
setting a grouping rule for generating a group of other print server of distribution destination to request to process a job based on the calculated capability difference information;
dividing the plurality of jobs into groups based on the grouping rule; and
sending a job of a divided group to other print server specified by the grouping rule to request processing.

12. The processing management method according to claim 11, further comprising the steps of:
acquiring a plurality of setting status information indicating setting states of processable settings from the plurality of other print servers and calculates status difference information regarding a difference in the plurality of setting status information;
setting the grouping rule based on the status difference information; and
further-dividing the groups divided based on the capability difference information by using the grouping rule based on the status difference information or further-dividing the groups divided based on the status difference information by using the grouping rule based on capability difference information.

13. The processing management method according to claim 11, further comprising the step of:
setting the grouping rule based on the capability difference information regarding color mode, post-processing, or spot color.

14. The processing management method according to claim 12, further comprising the step of:
setting the grouping rule based on the status difference information regarding paper, color mode, or throughput.

15. The processing management method according to claim 11, further comprising the step of:
estimating processing cost for the groups to be divided according to each of the grouping rule and divides into optimal groups based on the processing cost.
